(19) United States
(12) Patent Application Publication
(10) Pub. No.: US 2015/0243404 A1
(43) Pub. Date: Aug. 27, 2015

(54) Polydimethylsiloxane (PDMS) Based Composite and Synthesis Method Thereof

(71) Applicant: Nano and Advanced Materials Institute Limited, Clear Water Bay (HK)

(72) Inventors: Kei Yeung Wong, Hong Kong (HK); Weijia Wen, Hong Kong (HK)

(73) Assignee: Nano and Advanced Materials Institute Limited, Clear Water Bay (HK)

(21) Appl. No.: 14/187,314

(22) Filed: Feb. 23, 2014

(51) Int. Cl. H01B 1/22

(52) U.S. Cl. CPC H01B 1/22

(57) ABSTRACT

A PDMS-based composite and a synthesis method thereof are disclosed. The PDMS-based composite comprises a PDMS gel and a plurality of conducting particles distributed within the PDMS gel. The weight percentage of the conducting particles in the PDMS-based composite is in the range of 86% to 91%. The synthesis method comprises the steps of: wetting a plurality of conducting particles using a low flash point solvent; mixing the wetted conducting particles with a PDMS gel; evaporating the low flash point solvent to form a mixture; and curing the mixture to form the product per se.

### FIELD OF INVENTION

This invention relates to a polydimethylsiloxane (PDMS)-based composite and the synthesis method thereof. In particular, the present invention relates to a PDMS-based conducting and magnetic composite.

### BACKGROUND OF INVENTION

In recent years, there has been considerable progress on fabricating devices by using PDMS-based conducting and/or magnetic composite. One of the major applications of such composite is fabricating the electrodes, micro-sensors or micro-heaters, etc. in the microfluidics regime [1-2]. PDMS has played a very important role for building micro-devices because of the properties like transparency, biocompatibility and good flexibility [3]. However, PDMS itself is a non-conducting and non-magnetic polymer. It is very difficult to be patterned with the metallic structure due to weak adhesion between metal and PDMS. Therefore, techniques of mixing the conducting particles with PDMS gel in the integration of microfluidic chip are very essential.

Starting from the first report of mixing carbon fibers into PDMS by Graron et al. in 2001 [4], many different PDMS-based composites are invented for different uses: Cu+PDMS composite [5] for mechanical applications; Ag+PDMS composite [6] for conducting purpose; Ni+PDMS composite [5] and Fe₃O₄@Ag composite [7] for the magnetoresistive and piezoresistive purposes; Fe(CO)₅+PDMS [8] for magnetic valves in microfluidic devices; and Fe+PDMS composite [9], CoFe₂O₄+PDMS composite [10] and Fe₂₋ₓCoSmₓO₄+PDMS [11] composite for magnetorheological (MR) elastomers.

Among the aforesaid PDMS-based composites, Ni+PDMS composite is commonly used as a pressure sensor because of its obvious effect of piezoresistivity. Recent work suggested the resistivity of Ni+PDMS samples reduces dramatically about 10 orders when high pressure is applied. However, the resistivity of the compressed sample is still too high to be considered as electrical conductor. On the other hand, Ag+PDMS composite is a promising material for low resistivity and therefore suitable for any electrical applications. However, due to the high concentration of Ag in Ag+PDMS, uniformity is a great concern. For the conducting and magnetic application, Fe₃O₄ coated with Ag particle (Fe₃O₄@Ag) is one of the solutions to make the conducting particles magnetic but the fabrication process of particles is complicated and not easy to control.

Most of the aforesaid PDMS-based composites are synthesized by direct mixing the corresponding particles with the PDMS gel, i.e., by simply pouring solid particles in PDMS gel and stirring until the gel become uniform. It is believed that the above process is not a good method as there is so little solvent (PDMS) to dissolve all the particles when a high concentration of solid particles in PDMS composite is required. Furthermore, stirring is difficult because of the high viscosity of the particles+PDMS gel. For instance, it is difficult to fabricate 88% wt (weight percentage) Ag+PDMS composite by mixing 17.6 g of Ag power with only 2.4 g of PDMS gel uniformly. It should also be noted that some of the aforesaid complex particles, for instance like Fe₃O₄@Ag, CoFe₂O₄ or Fe₂₋ₓCoSmₓO₄, are not readily available which are difficult to synthesize.

### SUMMARY OF INVENTION

In the light of the foregoing background, it is an object of the present invention to provide an alternative method of synthesizing PDMS-based composite.

Accordingly, the present invention, in one aspect, is a method of synthesizing PDMS-based composite which comprises the steps of (1) wetting a plurality of conducting particles using a low flash point solvent; (2) mixing the conducting particles with a PDMS gel; (3) evaporating the low flash point solvent to form a mixture; and curing the mixture to form the PDMS-based composite.

In one embodiment, the conducting particles are selected from a group consisting of silver, nickel, iron and gold; and the average size of the conducting particles range from 1.2 μm to 5 μm.

In another embodiment, the low flash point solvent is selected from a group consisting of acetone, hexane and heptane.

In another embodiment, the evaporating step is conducted under room temperature for 24 hours.

In another embodiment, the curing step further comprises a step of heating the mixture at 60° C. for 48 hours.

In one embodiment, the method of synthesizing PDMS-based composite further comprises a step of sonicating the plurality of conducting particles; wherein the duration of the sonicating step is 15 minutes.

According to another aspect of the present invention, a PDMS-based composite is disclosed. The PDMS-based composite comprises a PDMS gel and a plurality of conducting particles distributed within the PDMS gel; wherein the weight percentage of the conducting particles in the PDMS-based composite is in the range of 86% to 91%.

In one exemplary embodiment, the conducting particles are selected from a group consisting of silver, nickel, iron and gold and the average size of the conducting particles ranges from 1.2 μm to 5 μm.

In an exemplary embodiment, silver is used as the conducting particle and the weight percentage of the silver in the PDMS-based composites is in the range of 88% to 90% and conductivity of the corresponding PDMS-based composite is in the range of 10⁻² Sm⁻¹ to 10⁴ Sm⁻¹.

In an exemplary embodiment, nickel is used as the conducting particle and the weight percentage of the nickel in the PDMS-based composites is in the range of 87% to 90% and the resistivity of the corresponding PDMS-based composite drops in more than 7 orders of magnitude when a compressive stress applied is increased from 0 kPa to 250 kPa.

There are many advantages to the present invention. First of all, the synthesis method presented can increase the solubility of metal particles in PDMS and reduce the electrical resistivity of resulting PDMS-based composite. Moreover, it can also make the spreading of metal particles in the composite more uniform.

Another advantage of the presented method is that no heating is required in order to evaporate the solvent due to its low flash point property. Such method can also minimize the insulating effect of the PDMS-based composite.

### BRIEF DESCRIPTION OF FIGURES

FIG. 1 shows the method of synthesizing PDMS-based composite according to one embodiment of the present invention.

FIG. 2 shows the resistance of three cylindrical samples (diameter: 52.7 mm, height: 7 mm) of Ni+PDMS composite before, during and after a compressive stress of about 32 kPa applied with different concentration of Ni according to one embodiment of the present invention.

FIGS. 3a to 3c show the electrical and mechanical characteristics cylindrical sample (diameter: 52.7 mm, height: 23.8 mm) of 90% wt Ni+PDMS composite according to one embodiment of the present invention. In particular, FIG. 3a shows the resistivity of the sample against compressive stress applied on the sample; FIG. 3b shows the compressive stress applied on the sample against strain applied on the sample; and FIG. 3c shows the resistivity of the sample against strain applied on the sample.

FIGS. 4a to 4b show the comparison of electrical characteristics of the first and second compressions on the 90% wt Ni+PDMS cylindrical sample (separated by 10 min) according to one embodiment of the present invention. In particular, FIG. 4a shows the logarithm graph of resistivity of the sample against stress applied on the sample; and FIG. 4b shows the graph of resistivity of the sample against compressive stress with focus at the low resistivity region.

FIGS. 5a to 5b show the electrical characteristics and the Young's modulus of Ag+PDMS composites according to one embodiment of the present invention with different concentrations of Ag. In particular, FIG. 5a shows the conductivity of the sample against concentration of Ag; and FIG. 5b shows the Young's modulus of the sample against concentration of Ag.

FIGS. 6a to 6e show the schematic illustration of the photolithography technique according to one embodiment of the present invention.

FIG. 7 show the micro-heaters with different channel widths according to different embodiments of the present invention. In particular, FIG. 7a shows a micro-heater with channel width of 10 μm; FIG. 7b shows the size of a 100-μm micro-heater according to an embodiment of the present invention; FIG. 7c shows the microscopic photo of the channel of 100-μm micro-heater according to the same embodiment as of FIG. 7c; and FIG. 7d shows the size of a 500-μm micro-heater.

FIG. 8 shows the thermal characteristics of Ag+PDMS micro-heater according to one embodiment of the present invention under an applied voltage of 3.5V.

FIGS. 9a to 9b show the set-up for polymerase chain reaction (PCR) according to an embodiment of the present invention. In particular, FIG. 9a shows the temperature control box; and FIG. 9b shows the stand for the PCR chip and the cooling system.

FIGS. 10a to 10b show the thermal cycles of PCR and the PCR result according to the same embodiment as of FIG. 9. In particular, FIG. 10a shows the 25 thermal cycles with 30 s at 91° C. and 30 s at 71° C.; and FIG. 10b shows the gel electrophoresis image for the PCR result: I. DNA marker, II. PCR performed in bench machine, and III. PCR performed in Ag+PDMS micro-heater.

FIGS. 11a to 11b show the set-up for testing the bond strength according to an embodiment of the present invention. In particular, FIG. 11a shows the tube for compressed air (CA) fed in, the knot that controls the CA pressure, the DPI 104 300 psi g, S/N air gauge, and the sample of PDMS-based composite; and FIG. 11b shows the schematic diagram of the set-up.

FIG. 12 shows the summarized result of bond strength by using different bonding techniques with different PDMS-based composites according to different embodiments of the present invention.

FIGS. 13a to 13b show the process of plasma activated bonding. In particular, FIG. 13a shows some of the —CH3 groups are replaced by —OH group after plasma activation; and FIG. 13b shows two —OH are condensed to form —O— after heating.

FIGS. 14a to 14j show 2-D circuit boards of different sizes according to different embodiments of the present invention. In particular, FIGS. 14a to 14i show nine different 10×10 mm² circuit boards with channel width of 300 μm; and FIG. 14j shows a circuit board with A4 paper size having channel width of 900 μm.

FIG. 15a shows the top view a 50×50 mm² two-layered conducting circuit board with the cross section of channels with dimension of 500×800 μm². FIGS. 15b to 15c show the fabrication procedure of the two-layered conducting circuit board as shown in FIG. 15a.

FIG. 16a shows the setup of cell culture. Cell culture chip was maintained at 37° C. by underneath microheater and in a 5%-CO2-humidified chamber. HeLa cells were cultured, in Minimum Essential Medium supplemented with 10% fetal bovine serum (FBS), 100 unit/mL penicillin and 100 mg/mL streptomycin. FIG. 16b shows an image of HeLa cells under microscope. (After seeding on the cell chip, HeLa cell was cultured for 20 hours.)

### DETAILED DESCRIPTION OF THE PREFERRED EMBODIMENTS

As used herein and in the claims, “comprising” means including the following elements but not excluding others.

As used herein an in the claims, the word “simple” refers to the particle powder could be readily purchased in any chemicals supplier. It is not necessary to synthesize the particle powder in-house.

As used herein and in the claims, “PDMS-based composite” refers to a composite chemical structure comprising at least one conducting (and magnetic) particle component that imparts low electrical resistivity (and magnetic property) to all or portion of the entire structure; wherein “conducting (and magnetic) particle component” refers to a micro-sized particle component that is electrically conductive with or without magnetic property and the phrase “low electrical resistivity” refers to the resistivity in the order of 10⁻³ Ωm or below.

As used herein and in the claims, the phrase “solvent with low flash point” or “low flash point solvent” refers to a solvent that has a flash point below 0° C.

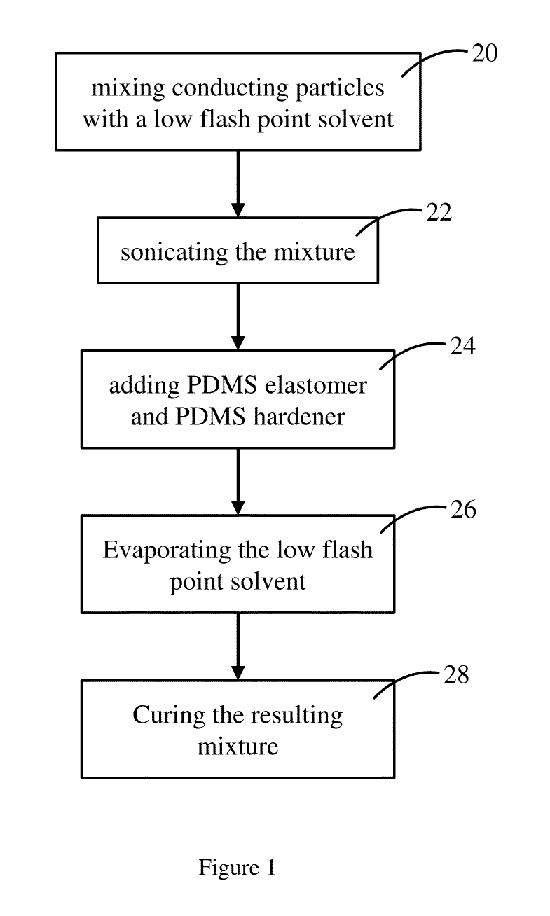

Referring now to FIG. 1, the first aspect of the present invention is a method of synthesizing a PDMS-based composite. The first step 20 of the method is mixing conducting particles with a low flash point solvent. After that the wetted conducting particles are sonicated to prevent any aggregation of the particles in the second step 22. Afterwards, PDMS gel is mixed with the wetted conducting particles in the third step 24. In one embodiment of the present invention, the PDMS gel comprises PDMS elastomer and PDMS hardener. In a particular implementation, the weight ratio of the PDMS elastomers and PDMS hardener is 10:1 in the PDMS gel. In the fourth step 26, the low flash point solvent is evaporated from the mixture. In one embodiment, the evaporation of the low flash point solvent is conducted without heating. Lastly the resulting mixture is cured to obtain the PDMS-based composite in step 28.

In one embodiment, the conducting particles are selected from a group consisting of nickel and silver. In yet another embodiment, the conducting particles are micro-sized metal particle with an average size ranging from 1.2 μm to 5 μm. In one embodiment, the low flash point solvent is selected from a group consisting of acetone, hexane and heptane.

In one embodiment, the fourth step 26 is conducted under room temperature for 24 hours in a fume hood. In another embodiment, heat curing is used in step 28. In a particular implementation of the present method, the heat curing is conducted by heating the mixture at 60° C. for 48 hours in an oven.

According to another aspect of the present invention, a PDMS-based composite is disclosed. The PDMS-based composite comprises a PDMS gel and a plurality of conducting particles distributed within the PDMS gel. The weight percentage of the conducting particles in the PDMS-based composite is in the range of 86% to 91%.

In one embodiment, the conducting particles are selected from a group consisting of nickel and silver. In yet another embodiment, the conducting particles are micro-sized metal particles with an average size ranging from 1.2 μm to 5 μm.

In one embodiment, silver micro-particles are selected as the conducting particles used in the PDMS-based composite. Accordingly, the weight percentage of silver particles in the resulting PDMS-based (Ag+PDMS) composite is in the range of 88% to 90%. Furthermore, the conductivity and Young's modulus of the resulting Ag+PDMS composite are in the range of 10⁻² Sm⁻¹ to 10⁴ Sm⁻¹ and 0.9 MPa to 2.1 MPa respectively.

In yet another embodiment, nickel micro-particles are selected as the conducting particles used in the PDMS-based composite. The resistivity of the resulting PDMS-based (Ni+PDMS) composite is less than 10⁻³ Ωm when a compressive stress is applied on the resulting Ni+PDMS composite. Moreover, the resistivity of the resulting Ni+PDMS composite drops in more than 7 orders of magnitude when the applied compressive stress applied increases from 0 kPa to 250 kPa.

### Synthesis of PDMS-Based Composite

In order to demonstrate the method as claimed, an illustrative example of synthesizing Ni+PDMS is discussed below. First of all, a given amount of Ni powders (for example: Sigma Aldrich, powder size <5 μm) is mixed with acetone (flash point: −17° C.) to wet the particles completely. Sonication was carried out for 15 minutes to separate any aggregated particles. This procedure makes the particle size return to the size when it was produced in factory and it would make the particles spread in the PDMS+acetone solution more thoroughly. PDMS (for example: Dow Corning, SYLGARD 184) comprises “elastomer” and “hardener”. The elastomer and hardener are used in 10:1 weight ratio in this illustrative example. A suitable amount of PDMS elastomer is added to the Ni+acetone solution and stirred gently until the mixture becomes a homogenous solution. After that, a suitable amount of PDMS hardener is added into the homogenous solution and stirred thoroughly. In one particular implementation, 19.8 g Ni powders, 2 g PDMS elastomer and 0.2 g PDMS hardener are utilized to synthesize 22 g 90% wt Ni+PDMS composite.

The final solution (Ni+acetone+PDMS elastomer+hardener) is put in the fume hood for a period of time such that all acetone has been evaporated. In one embodiment, the aforesaid period is about 24 hours. The main reason of using a solvent with low flash point is that no heating is required to force the solvent out before curing. Heating before curing does not favor the synthesis process because when impurity is present in the solvent, such heating step makes the PDMS mixture starts to cure and the molecules of the solvent will be trapped within the PDMS mixture. It will then be hard for the solvent to be vaporized completely. Moreover, voids form even the molecules can escape such that the resistivity of the PDMS-based composite will be increased.

Furthermore, evaporation of the solvent with low flash point takes away the heat from the solution and decreases the temperature of the solution which further reduces the rate of curing when the impurity is present. Also, since the mixture is not yet cured while acetone is evaporating, the Ni particles and PDMS molecules can replace the voids that are originally filled with acetone. Therefore, Ni particles are more densely packed in the composite and so resistivity of the resulting composite is reduced.

After the evaporation of acetone, the solution is heated in the oven at 60° C. for 48 hours. No cracks are found in the synthesized samples. Furthermore, the resulting samples are sponge-like, which are compressible and flexible.

In another illustrative example, Ag powders (for example: Unist Business Corp. (Shanghi), powder size ˜1.2-2.2 μm) are used as the conducting particles. The synthesizing steps as described in the foregoing illustrative example can be applied to synthesize Ag+PDMS composite.

Characterization of PDMS-Based (Ni+PDMS) Composite (without Patterning)

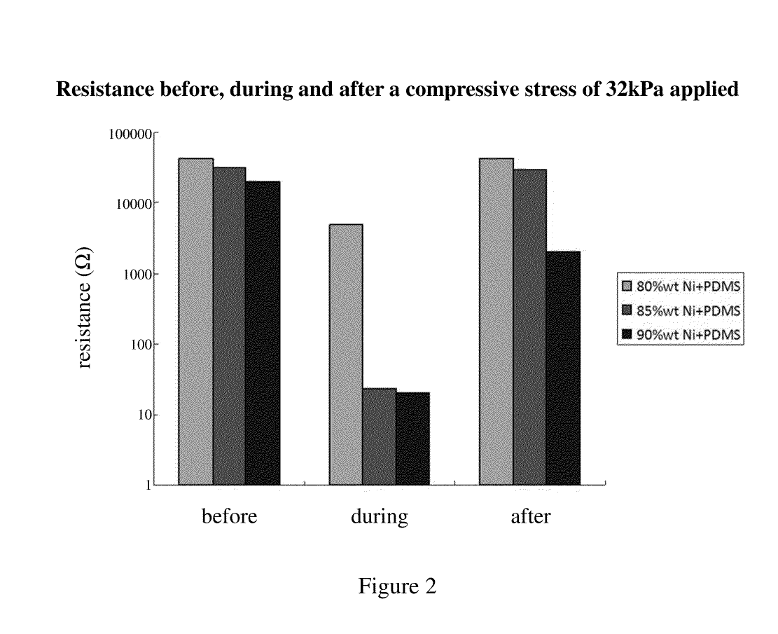

The characteristics of the Ni+PDMS composite obtained according to the forgoing illustrative example is now discussed. Referring to FIG. 2, the resistances of three cylindrical samples of different concentrations of Ni in Ni+PDMS composite (with diameter of 52.7 mm and height about 7 mm) are studied in which the resistances of the samples before, during and after a compressive stress of about 32 kPa applied are measured. There is about one order of magnitude dropped on resistance of 80% wt Ni+PDMS composite upon application of the compressive stress. In contrast, the drops of resistances of 85% wt and 90% wt Ni+PDMS composites upon application of the compressive stress are very obvious with more than 3 orders of magnitude. And the resistance of 90% wt Ni+PDMS composite is less reversible than 85% wt Ni+PDMS composite. This is favorable if low resistivity is needed to be maintained.

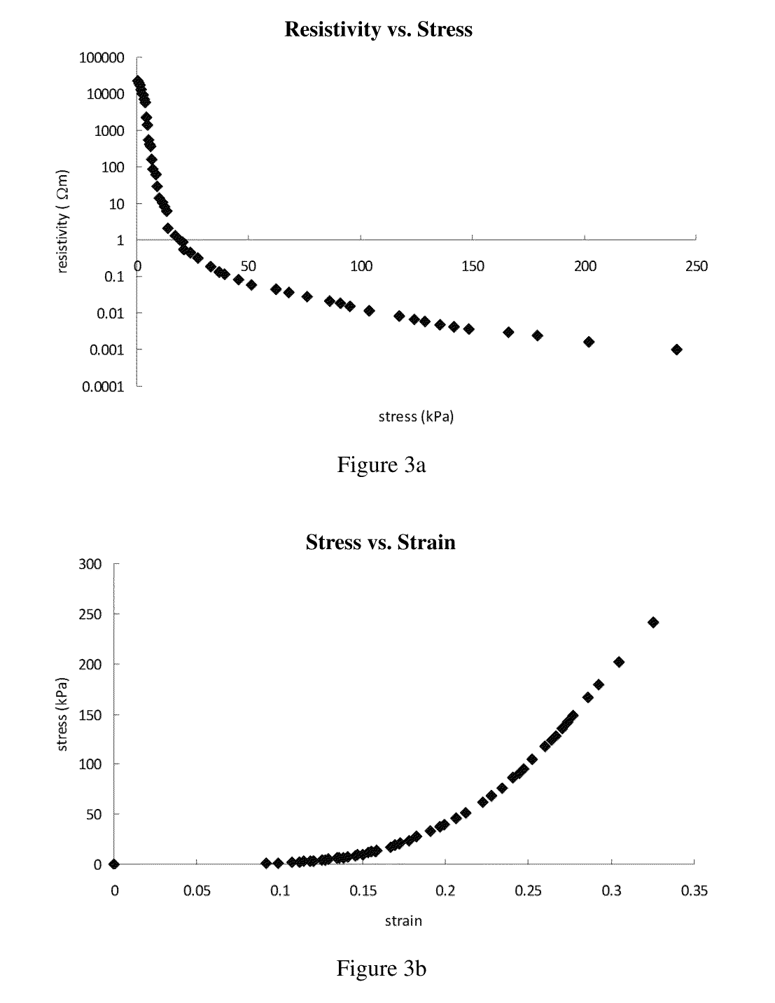

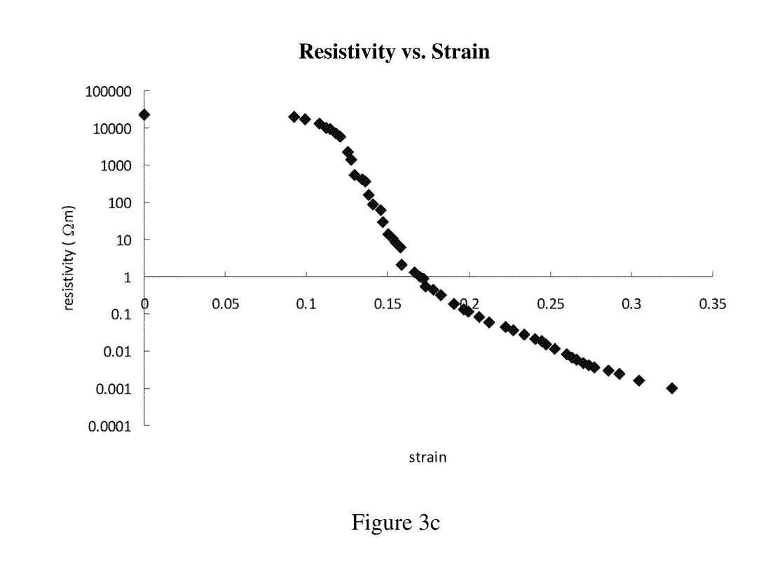

Relationships between resistivity and strain with the change of compressive stress on the 90% wt Ni+PDMS composite were also examined. For the resistivity and strain measurement, a cylindrical sample of 90% wt Ni+PDMS composite (with diameter of 52.7 mm and height about 23.8 mm) was prepared for a pushing system made in-house (comprising a Chatillon digital force gauge, THK LM guide actuator KR). By compressing the sample, the applied force and displacement compressed could be obtained by the pushing system. Resistance of the sample was measured by a multimeter (Agilent 34410A 6½ digital multimeter). The compressive stress, resistivity and strain were then calculated. The results are plotted in FIGS. 3a to 3c. FIG. 3a shows that the resistivity of the 90% wt Ni+PDMS composite decreases rapidly in low compressive stress region while the decrease slows down in the high compressive stress region. It should be noted that the resistivity of the 90% wt Ni+PDMS composite can have a drop of more than 7 orders of magnitude (from 2.3×10⁴ Ωm to 9.8×10⁻⁴ Ωm) only when a compressive stress applied is increased from 0 kPa to about 250 kPa. FIG. 3b shows that strain changes linearly with the applied compressive stress in the high compressive stress region. From FIG. 3c, the resistivity of the Ni+PDMS composite is expected to be even lower and closer to that of Ag+PDMS (about 10⁻⁴ Ωm) when the strain further increases.

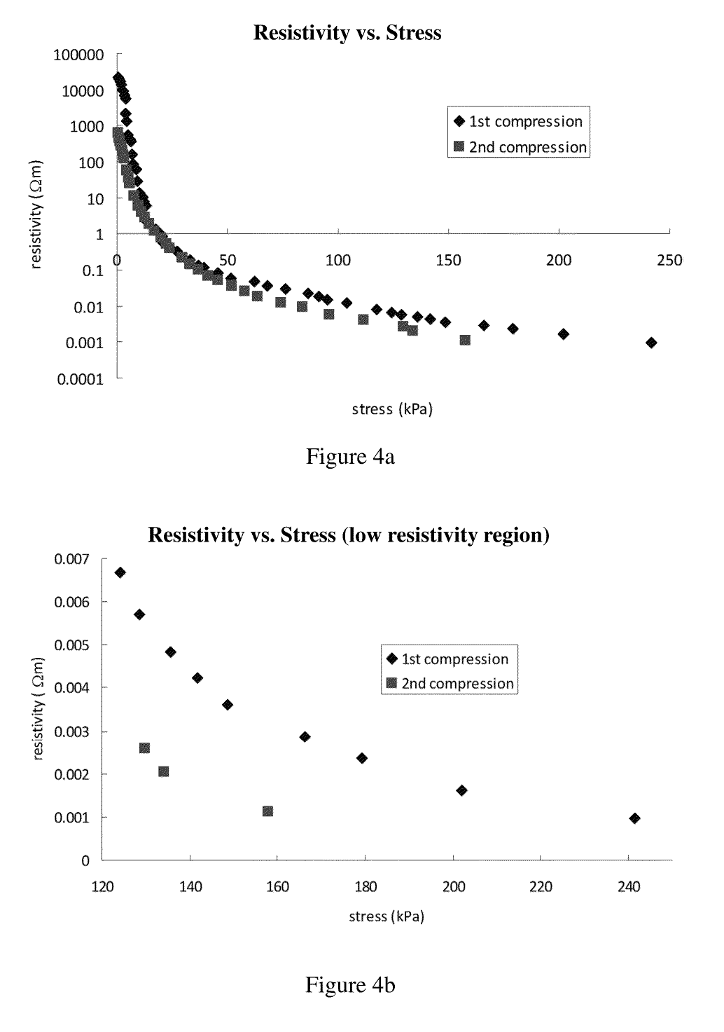

FIGS. 4a to 4b show that the resistivity of the 90 wt % Ni+PDMS composite of the first and second compression (separated by 10 minutes). It is clearly shown that the resistivity of low compressive stress is significantly reduced in the second compression since the 90% wt Ni+PDMS composite is less reversible. However, the resistivity in the second compression can also reach 1.1×10⁻³ Ωm, which is about the same as that in the first compression (9.8×10−4 Ωm) (referring to FIG. 4b). By compressing the composite repeatedly and longer each time, the 90% wt Ni+PDMS composite can have a low enough resistivity and be considered as a conductor even no compressive stress is applied.

### Characterization of Bulk PDMS-Based (Ag+PDMS) Composites

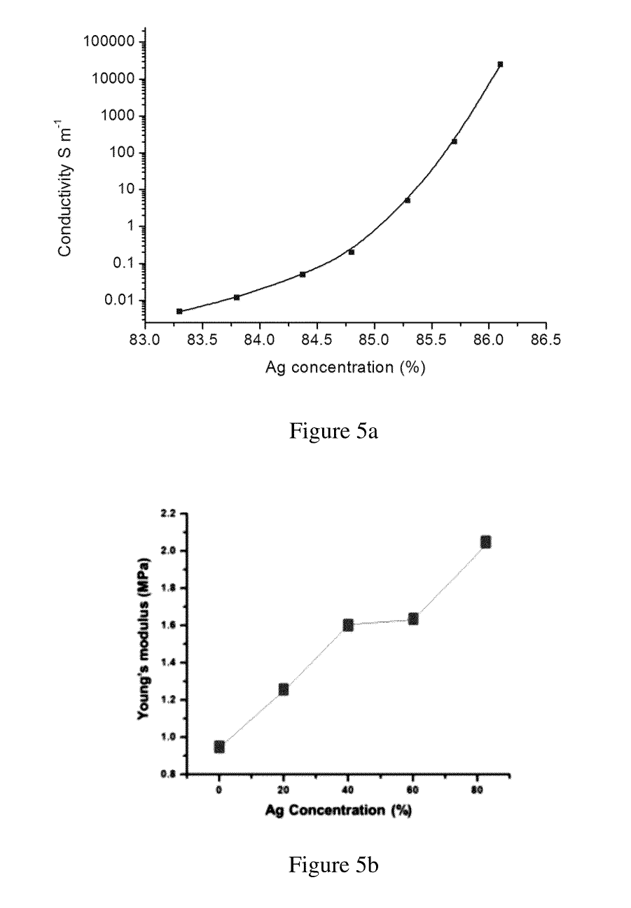

The conductivity of Ag+PDMS composite with different concentrations of Ag is shown in FIG. 5a. The threshold concentration for the onset of good conductivity in Ag+PDMS composites is about 83% wt Ag. The conductivity is observed to increase rapidly beyond the threshold, where an increase of more than 6 orders of magnitude (from below 10⁻² Sm⁻¹ to above 10⁴ Sm⁻¹) is observed only when the concentration of Ag increases from about 83% wt Ag to more than 86% Ag. The conductivity of 86% Ag+PDMS composite is comparable to that of tetrathiafulvene-tetracyanoquinodimethane (TTF-TCNQ)—the current commonly used organic conductor.

The mechanical reliability of Ag+PDMS composite under deformation processing was also examined. The samples prepared were 25×1×1 mm³ strips of Ag+PDMS composites with different concentrations of Ag for the experiment in a pulling system (MTS, Alliance RT/5). The Young's modulus is calculated from the tensile stress—strain curve obtained by the system. The Young's modulus of the Ag+PDMS composite with different concentrations of Ag is shown in FIG. 5b. It can be observed that the Young's modulus increases from 0.9 MPa to 2.1 MPa as the concentration of Ag increases from 0% wt to 83% wt with a linear relationship.

### Application of the PDMS-Based Composites

Combining the techniques of photolithography, laser cutting and soft-lithography, many devices can be fabricated using the PDMS-based composites of the present invention, for instance micro-heaters, 2-D and 3-D conducting circuit boards applied in electronic and bio-system regimes.

### i) Fabrication of Micro-Heater

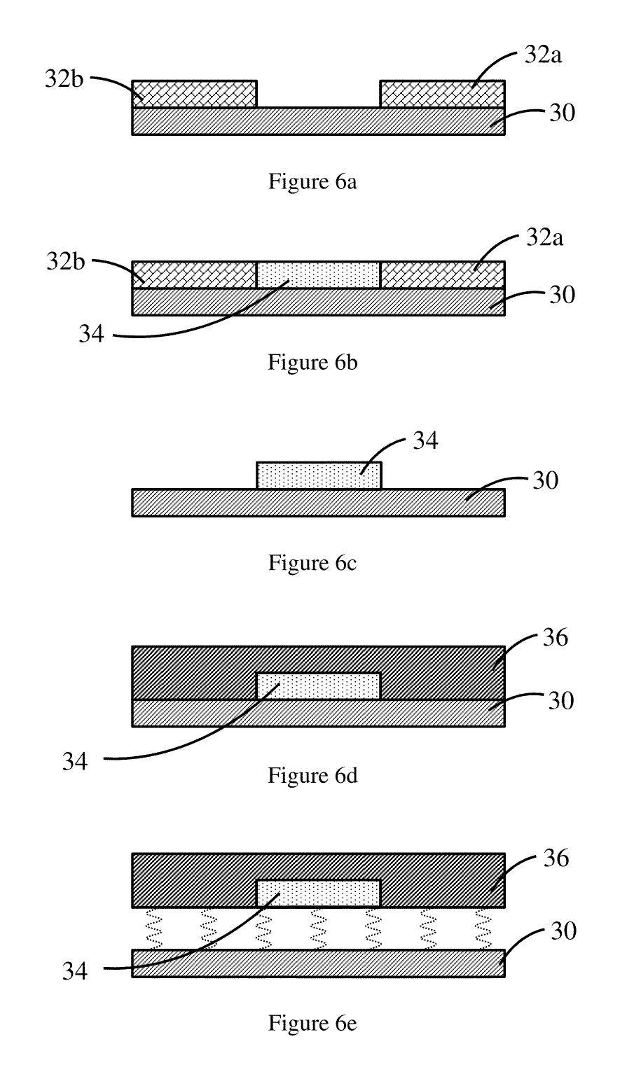

The method of fabricating micro-heaters with channel width smaller than 300 μm, i.e. photolithography technique, is shown in FIGS. 6a to 6e. First of all, a layer of photoresist, 32a and 32b, is patterned on a substrate 30, as shown in FIG. 6a, using a standard photolithographic technique. This step is used to form a mold to pattern the PDMS-based conducting composite. After baking, the substrate 30 is treated with developer and rinsed by de-ionized water (DI water). A PDMS-based conducting gel is prepared by mixing PDMS and Ag powders together to form 88% wt to 90% wt Ag+PDMS gel as taught by the present invention. The Ag+PDMS gel 34 (composite before cured) is then plastered on the mold as shown in FIG. 6b. Unnecessary portion of the gel (which is outside the pattern and on the photoresist) is removed from the mold surface to ensure and a clean and preferred pattern of Ag+PDMS gel 34 in the mold. The gel is then cured (for example: by baking at 100° C. for 24 hours). After curing, the photoresists 32a and 32b are removed from the substrate as shown in FIG. 6c. In one implementation, the photoresist 32a and 32b are removed by dipping the whole substrate into a solvent and then washed with DI water. After heating, only the Ag+PDMS composite 34 is left on the substrate 30. To support Ag+PDMS conducting channels, a thick layer of pure PDMS gel 36 is poured on the substrate 30 as shown in FIG. 6d. The whole matrix is then heated up in an oven (for example: at 60° C. for 1 hour). Afterwards, the micro-heater can be easily peeled off from the substrate 30 as shown in FIG. 6e. Experiments show that the bonding between the conducting micro-structure and bulk PDMS was perfect and no de-bonding or cracks were found in the fabricated micro-heaters.

In one implementation, the photoresist is AZ4620; the substrate used could be selected from 100×100 mm² glass and 4″ silicon wafer. In another implementation, the developer used to treat the substrate 30 is FHD-5. In yet another implementation, the solvent used to remove the photoresist 32a and 32b are acetone and propan-2-ol.

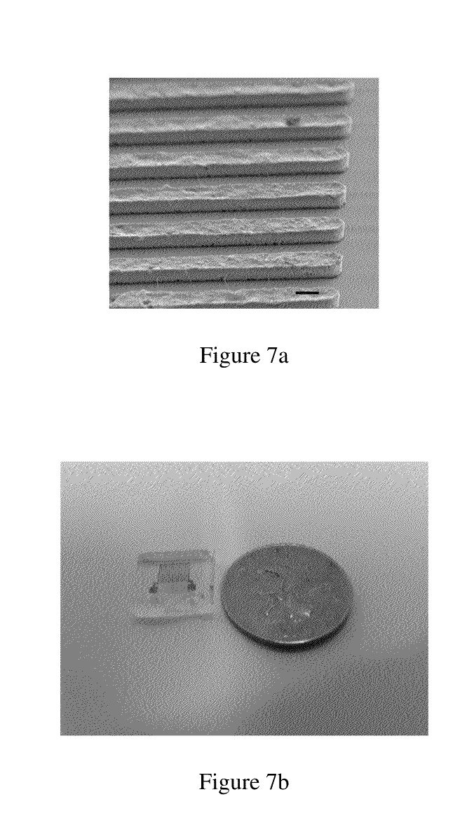

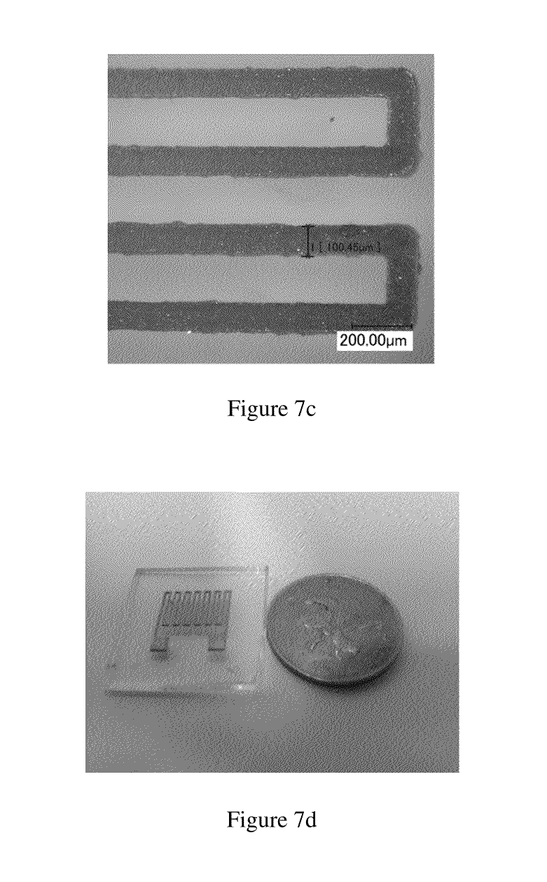

FIG. 7a shows the channel width of the patterned micro-heater can be as narrow as 10 μm. FIGS. 7b and 7c show a micro-heater fabricated with channel width of about 100 μm (100-μm micro-heater).

For fabrication of micro-heaters with channel width larger than 300 μm, laser-engraving technique is used instead of photolithography technique. A piece of plastics (for example: polymethylmethacrylate (PMMA)) is engraved by a laser-cutting system (Universal Laser System VLS3.50) to form a mold to pattern the PDMS-based composite. The PMMA mold is dipped in a solvent (for example: ethanol or propan-2-ol) to remove the plastic particles left on the mold and then rinsed by DI water. Ag+PDMS gel is then plastered on the mold. Unnecessary portion of the gel (which is outside the pattern) is removed by rubbing the plastic mold on a piece of clean paper. The gel is then cured. To support Ag+PDMS conducting channels, a thick layer of pure PDMS gel is poured on the substrate. After heating, the micro-heater can be easily peeled off from the plastic mold. Experiments show that the bonding between the conducting micro-structure and bulk PDMS was perfect and no de-bonding or cracks were found in the fabricated micro-heaters. FIG. 7d shows a 500-mm micro-heater.

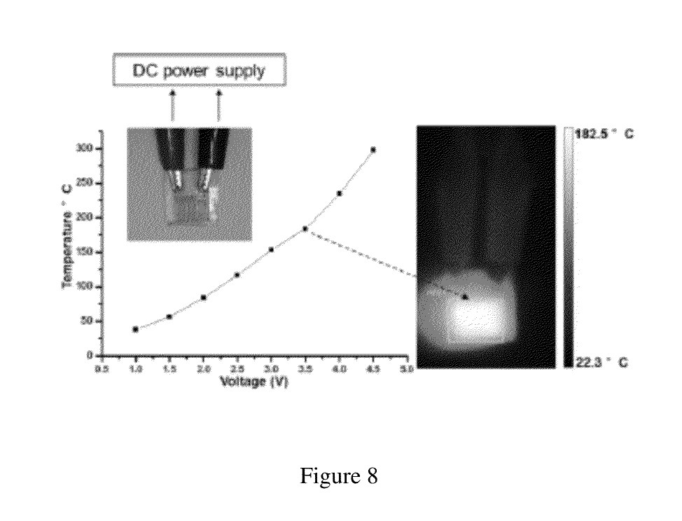

In order to examine the heating capability of the micro-heaters, an infrared (IR) camera (FLIR Systems trademark, model Prism DS) was employed to detect both the heat images and thermal characteristics when the micro-heater was subjected to different applied voltages. By using infrared sensing technique, accurate temperature readings as well as comprehensive thermal distribution patterns could be obtained. In the experiment, the relationship between temperature and applied voltage was determined by focusing the IR camera on the central helical range of the micro-heater. In FIG. 8, it is observed that the temperature rises monotonically from room temperature with increasing applied voltage. The local maximum temperature is seen to reach at about 300° C. when the applied voltage is 4.5 V. An actual IR image of the micro-heater taken at applied voltage of 3.5 V can be seen in the right panel of FIG. 8, where it is seen that the heating distribution has a rectangular shape. It is also obviously observed from the right panel that localized area is much larger than the size of the micro-heater with lower temperatures extending much further beyond the heater than the higher temperatures, as necessitated by heat conduction.

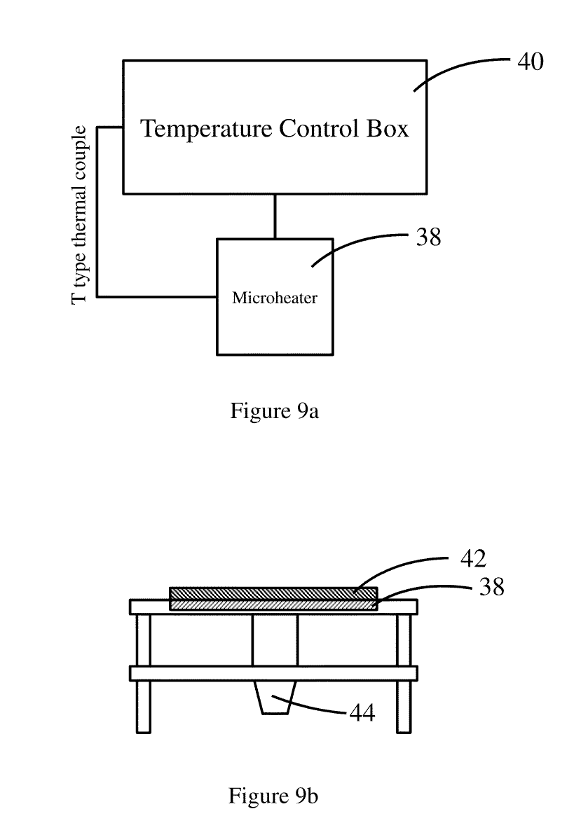

Multi-target heating of the aforementioned micro-heater is also demonstrated by a set-up of biological reaction—polymerase chain reaction (PCR). PCR is a well-known DNA amplification technique. This method repeats thermal cycling involving two or three temperature steps. The micro-heater 38 is connected into a custom-designed temperature control box 40 as shown in FIG. 9a to achieve temperature cycles. An open chamber 42 is directly mounted on the micro-heater 38 for accommodating PCR solution. To achieve fast cooling, compressed air (CA) was used to blow the PCR chip via a compressed air valve 44 as shown in FIG. 9b. CA was triggered to cool down the PCR chip by turning on the compressed air valve 44 during the cooling process. The compressed air valve 44 which is connected to the temperature control box 40 will be turned on or off automatically at the beginning or end of the cooling process. FIG. 10a shows the thermal cycles of the PCR and the gel electrophoresis image. In FIG. 10a, 25 thermal cycles with 30 s at 91° C. and 30 s at 71° C. are applied in the PCR. After 25 thermal cycles, the DNA is measured by the gel electrophoresis. FIG. 10b shows the gel electrophoresis image for PCR result by commercialized bench machine and Ag+PDMS micro-heater as taught by the present invention. The results shown in bands II and III conclude that the 400 base pairs (bp) of the DNA were successfully amplified both in bench machine and Ag+PDMS micro-heater. The result of the Ag+PDMS micro-heater is comparable to that of commercialized bench machine. The PCR result indicated the Ag+PDMS micro-heater as taught by the present invention could be further developed to apply into a wide range of biological reaction.

### ii) Fabrication of Two-Layer PDMS-Based Composite Structures

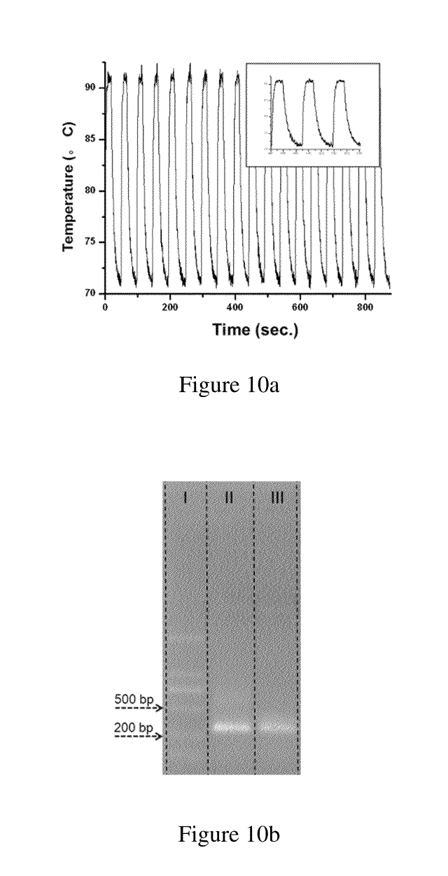

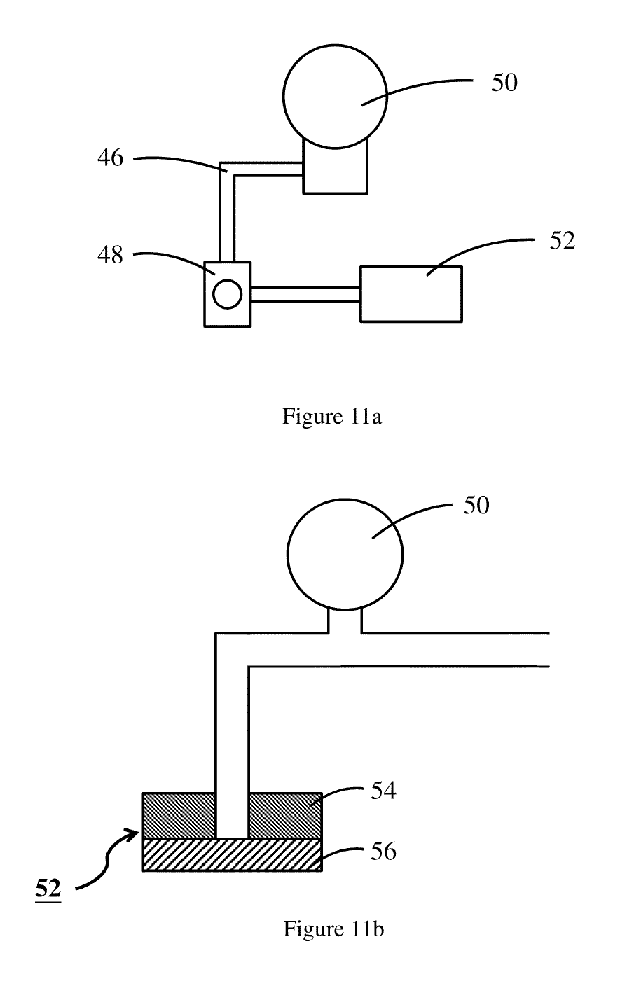

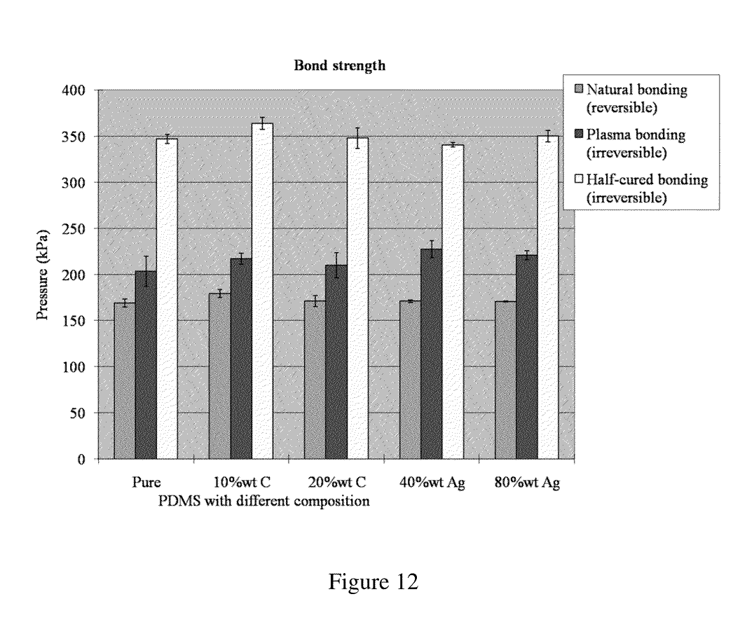

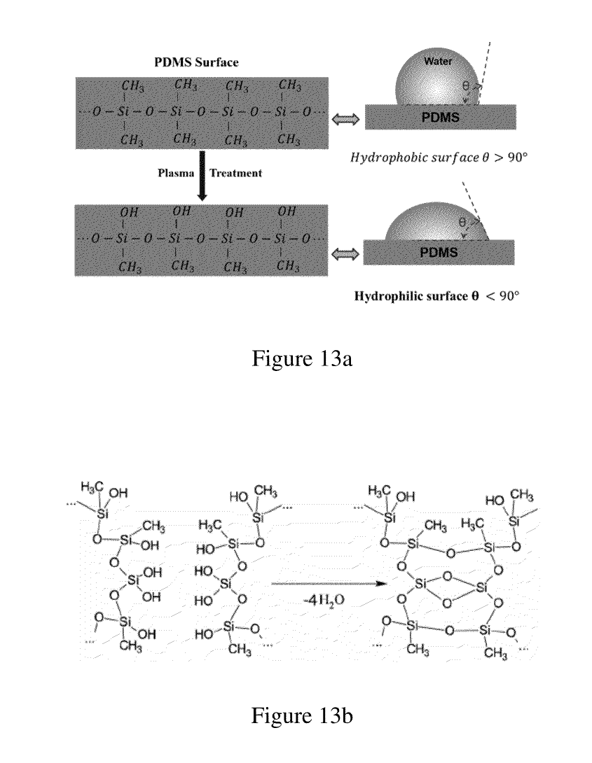

In order to build up complicated devices based on PDMS-based composite of the present invention, it is important to study the direct PDMS-based composite to pure PDMS bonding techniques, both reversible and irreversible. Three different bonding techniques are examined, namely: (a) natural bonding, (b) plasma activated bonding and (c) half-cured bonding. In natural bonding, two pieces of cured PDMS composites will bind together without any treatment on the corresponding surface. This bonding is reversible, i.e. they can be separated and bound together as many times as needed. For plasma activated bonding, the two pieces of cured PDMS composites will be treated in plasma ambience (Harrick Plasma Cleaner PDC-001/002) and then bound together. Half-cured bonding is a technique in which one piece of the cured PDMS composites and another piece of the half cured PDMS composite are bound together and then the complex is cured thoroughly. The last two bonding techniques are irreversible and forced separation will damage the surface of the pieces of PDMS composites. In the experiment of bond strength testing, two pieces of PDMS-based composites with the size of 8.5×8.5×2 mm³ are prepared. One of the pieces comprises different PDMS-based composites (layer A) including pure PDMS, 10% wt C+PDMS composite, 20% wt C+PDMS composite, 40% wt Ag+PDMS composite and 80% wt Ag+PDMS composite. Carbon black powder may be sourced from, for example, Vulcan XC72-R, Cabot Inc., USA. A hole with diameter about 1 mm was pinned in layer A. Another piece (layer B) is pure PDMS. The procedure described above or any other procedures known in the art can be used in preparing the PDMS-based composites for the bond strength testing except the time of curing and plasma activation are different. Details of curing and plasma activation times are listed in table 1. FIG. 11a and FIG. 11b show one of the set-ups used to test the bond strength of the two-layer PDMS-based composites according to one embodiment of the present invention. The compressed air (CA) with 70 psi (about 483 kPa) is fed through the tube 46 in the set-up. CA passes through a knot 48 that can control the air pressure in the system and an air gauge 50 (Druck DPI 104 300 psi g, S/N) with maximum pressure measured at 300 psi (about 2.07 MPa) is used to measure the air pressure. Finally, CA is blocked by PDMS composites 52. The bond strength is defined by the smallest pressure which separates the PDMS complex back into two PDMS layers (layer A 54 and layer b 56). For each bonding technique of each material, 30 samples are tested. The result is summarized in FIG. 12. From FIG. 12, it is found that the irreversible bonding techniques greatly increase the bond strength of the PDMS-based composite and pure PDMS bonding. Moreover, FIG. 12 shows that the bond strength is more or less independent of the mass concentration of particles in PDMS of layer A. For plasma activated bonding, as explained in FIG. 13a, some of the methyl groups (—CH3) on the PDMS surface are replaced by hydroxyl groups (—OH). When two pieces of the PDMS are brought together and under heating, two —OH groups are condensed and form an oxy bonding (—O—) as shown in FIG. 13b, which is a permanent bond. For the half-cured bonding, as layer B has not yet been cured completely, layer B will keep making crosslink with layer A.

TABLE 1
Details of curing and plasma activation times

| | | | Plasma | |
|---|---|---|---|---|
| | | Natural | activated | Half-cured |
| | | bonding | bonding | bonding |
| Curing time (min) | A | 45 | 45 | 45 |
| | B | 45 | 45 | 25 |
| | | | | (half-cured) |

| | | | |
|---|---|---|---|
| Plasma activation time (min) | N/A | 2.5 | N/A |
| Post baking time (min) | 45 | 45 | 45 |

iii) Fabrication of Two-Dimensional (2D) Circuit Board Structures

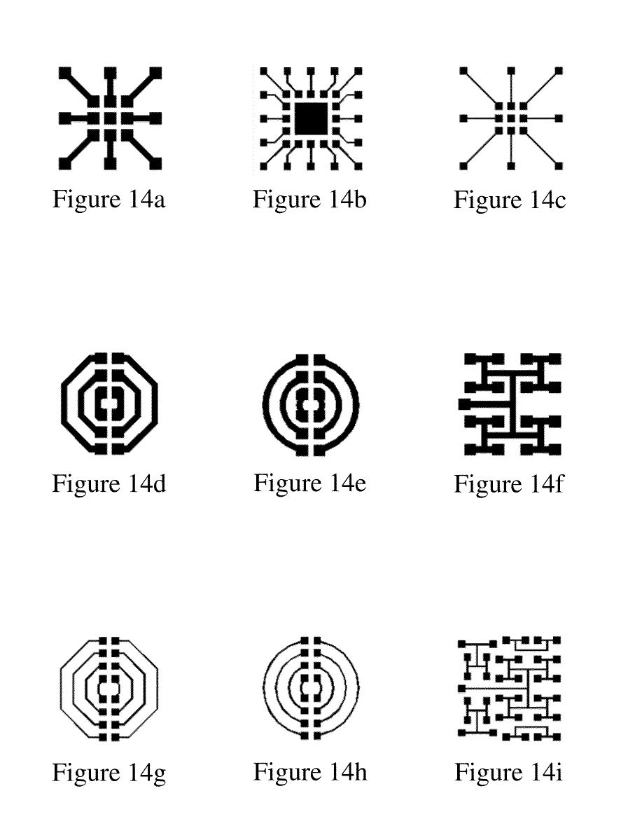

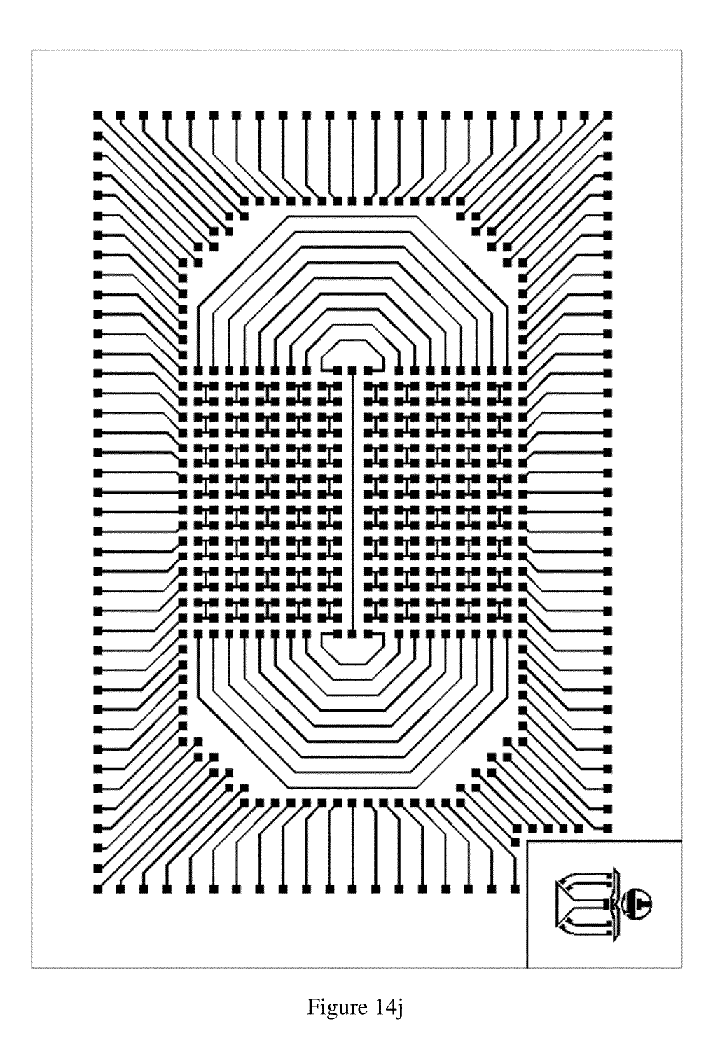

A 2D circuit board may be fabricated by the photolithography technique as shown in FIG. 6 or laser-engraving technique mentioned before. For the laser-engraving technique, the procedure is modified for better conducting ability for the PDMS-based composite. After plastering the Ag+PDMS composite in the channels, the PDMS-based composite is heated to half-cured. A piece of pure PDMS is prepared and heated to half-cured to form the support of the patterns of 2D circuit boards. The two pieces are bought and cured together under a small stress so that most of the air between the patterns of the 2D circuit boards and the support is forced to escape from the complex formed. It is discovered that fresh PDMS gel would leak into the spaces inside the cured Ag+PDMS patterns during degassing procedure. The leaked-in pure PDMS will increase the resistivity of the resulting Ag+PDMS composite. The leaked-in pure PDMS does not affect much on the micro-heaters as higher resistivity indeed favors the heating effect of the micro-heaters. However, the circuit boards are used for conducting and so the resistivity of the Ag+PDMS should be as low as possible. By the photolithography and laser-engraving techniques, any sizes of channel width of 2D circuit boards can be fabricated. FIGS. 14a to 14i show nine different circuit boards of sizes of 10×10 mm² with channel width of 300 μm and FIG. 14j shows a circuit board of a size of an A4 paper with channel width of 900 μm. It will be clear to one skilled in the art that the size of the 2D circuit boards and the corresponding channel width are not limited by the examples as shown in FIGS. 14a to 14j, which can be tailor-made according to any particular requirements.

### iv) Fabrication of Three-Dimensional (3D) Circuit Board Structures

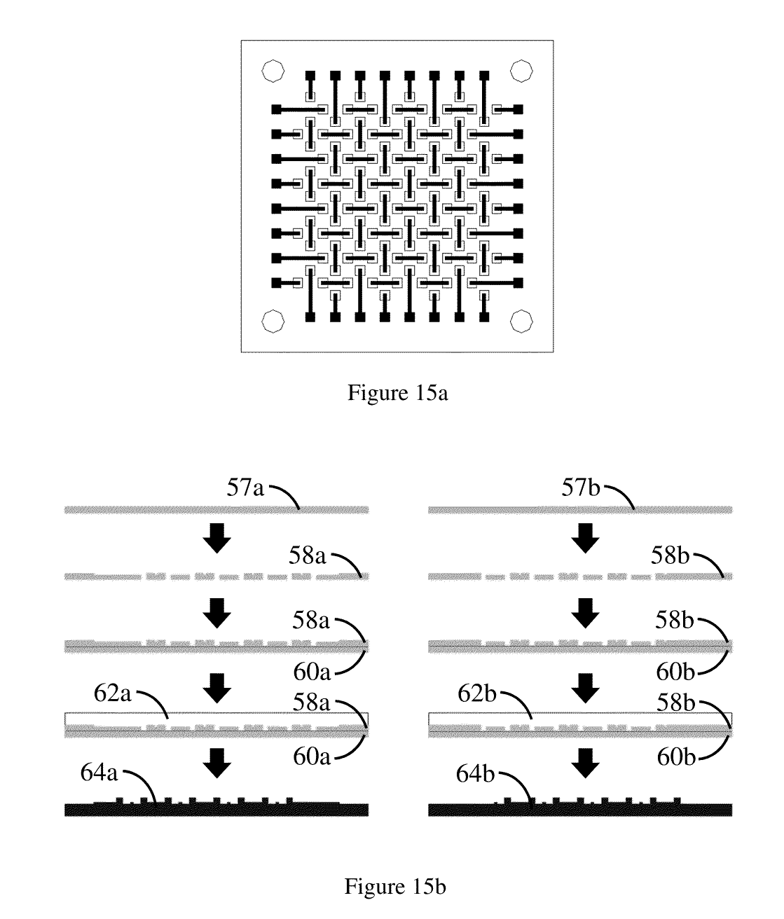

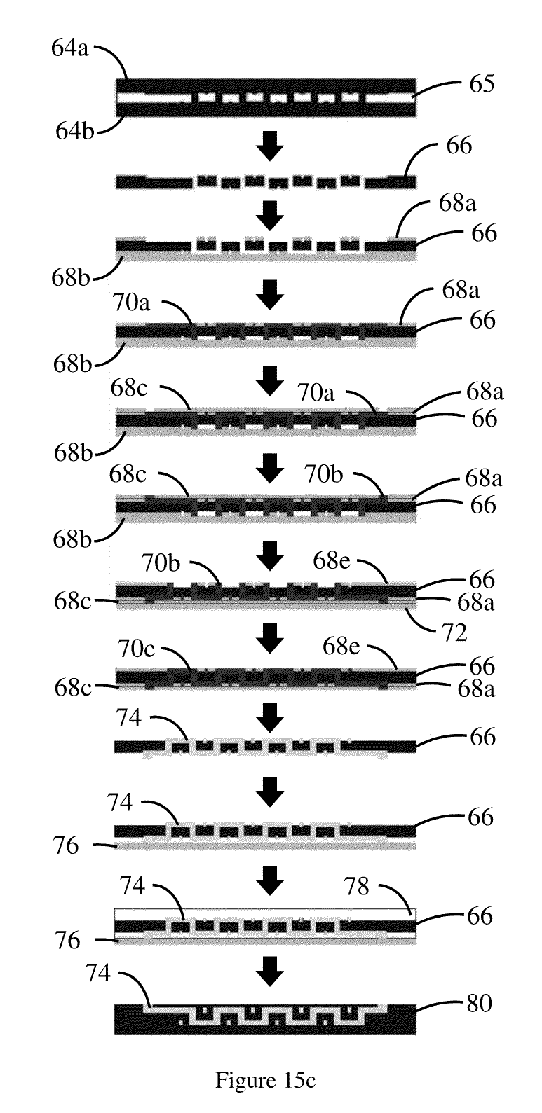

3D circuit boards may be fabricated by the similar process to 2D circuit boards. FIG. 15a shows the top view of a two-layered conducting circuits with size of 50×50 mm² according to a specific implementation of the present invention. The cross section of the channels is around 500×800 μm². In order to fabricate such two-layered conducting circuit, an upper layer and a lower layer are first fabricated separately by using the laser-engraving technique, as shown in FIG. 15b. First of all, two pieces of PMMA slides (57a and 57b) are engraved by laser-cutting system. The engraved PMMA slides 58a and 58b are then stacked with another PMMA slides (60a and 60b) respectively to form a mold. Pure PDMS gel 62a and 62b (composite before cured) are then plastered on the molds. The gel is then cure; in one embodiment, the gel is cured by baking at 80° C. for 2 hours. After curing, the PDMS composite 64a (also referring as upper layer) and 64b (also referring as lower layer) are removed from the molds. The inner surfaces of the upper layer 64a and the lower layer 64b are then coated with a layer of saline (not shown).

After the fabrication of the upper layer 64a and the lower layer 64b, the corresponding vertical channels are aligned and the upper layer 64a and the lower layer 64b are stacked face-to-face towards each other as shown in FIG. 15c. Pure PDMS 65 is then poured into the gaps between the channels. Afterwards, the whole complex is cured; in one embodiment, the complex is cured by baking at 80° C. for 2 hours. Due to the existence of the coating in the inner surface of the upper layer 64a and the lower layer 64b, the newly cured PDMS composite 66 could be readily removed from the upper layer 64a and the lower 64b. The newly cured PDMS composite 66 is then sandwiched between two another engraved PMMA slides 68a and 68b. Afterwards, Ag+PDMS gel 70a (composite before cure) is poured into the gaps between the channels. In order to produce electrodes for the circuit boards, a third engraved PMMA slide 68c is disposed on top of the engraved PMMA slide 68a and the additional gaps are then filled with Ag+PDMS gel 70b. The whole composite is then flipped over and a PMMA slide 72 is added as a support of the composite. The gaps between the channels on the other side of the composite are then filled with another Ag+PDMS gel 70c. The whole composite is then cured and all of the PMMA slides (68a, 68c and 68e) are removed. In order to fully cover the cured Ag+PDMS composite 74, a plastic slide 76 is placed under the cured composite, and pure PDMS gel 78 is then poured into the gaps. After curing, the cured Ag+PDMS composite 74 is fully covered by pure PDMS composite 80, thereby forming the two-layered conducting circuit. The fabrication cost of such a 3D circuit board is about HK$9.8.

### v) Fabrication of Flexible Conducting Board in Biomicrofludic Chips

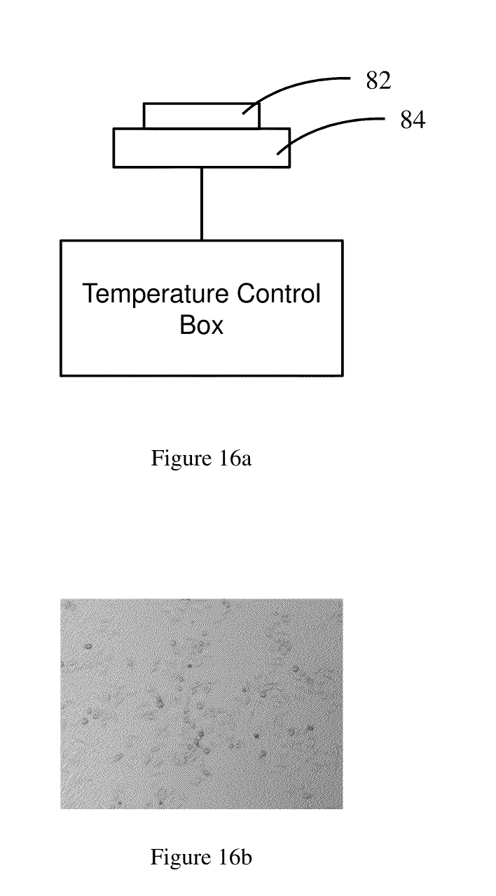

FIG. 16a demonstrates the control of temperature on biomicrofluidic chip 82 by a small 2D circuit board (micro-heater) 84 fabricated according to the aforesaid procedures for cell culture. In this experiment, HeLa cells, as shown in FIG. 16b, are cultured. The temperature of the cell culture chip is maintained at 37° C. (same as human body temperature) by the underneath micro-heater.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

### REFERENCE

1. T. Vikner, D. Janasek, and A. Manz, Analytical Chemistry, 76, 3373 (2004).
2. A. A. Darhuber, J. P. Valentino, J. M. Davis, S. M. Troian, and S. Wagner, Applied Physics Letters, 82, 657 (2003).
3. J. C. McDonald, G. M. Whitesides, Accounts of Chemical Research, 35 (7) 491 (2002).
4. A. J. Gawron, R. S. Martin and S. M. Lunte, Electrophoresis, 22, 242 (2001).
5. M. K. Abyaneh, S. Ekar and S. K. Kulkarni, Journal of Materials Science Research, Vol. 1, No. 3 (2012).
6. X. Z. Liu, S. L. Peng, L. Y. Liu, W. J. Wen and P. Sheng, Advanced Materials, 19 (18) 2682 (2007).
7. J. L. Mietta, M. M. Ruiz, P. S. Antonel, O. E. Perez, A. Butera, G. Jorge and R. M. Negri, Langmuir, 28 6985 (2012).
8. J. Li, M. Zhang, L. Wang, W. Li, P. Sheng and W. Wen, Microfluidics and Nanofluidics, 10 919 (2011).
9. K. Danas, S. V. Kankanala, N. Triantafyllidis, Journal of the Mechanics and Physics of Solids, 60 120 (2012).
10. P. S. Antonel, G. Jorge, O. E. Perez, A. Butera, A. G. Leyva and R. M. Negri, Journal of Applied Physics, 110 043920 (2011).
11. M. M. Ruiz, J. L. Mietta, P. S. Antonel, O. E. Rerez, R. M. Negri, G. Jorge, Journal of Magnetism and Magnetic Materials, 327 11 (2013).

What is claimed is:

1. A PDMS-based composite comprising:
a) a PDMS gel; and
b) a plurality of conducting particles distributed within said PDMS gel;
wherein the weight percentage of said conducting particles in said PDMS-based composite is in the range of 86% to 91%.

2. The PDMS-based composite of claim 1, wherein said conducting particles are selected from a group consisting of silver, nickel, iron and gold.

3. The PDMS-based composite of claim 2, wherein said weight percentage of said silver in said PDMS-based composite is in the range of 88% to 90%.

4. The PDMS-based composite of claim 2, wherein said weight percentage of said nickel in said PDMS-based composite is in the range of 87% to 90%.

5. The PDMS-based composite of claim 3, wherein the conductivity of said PDMS-based composite is in the range of 10⁻² Sm⁻¹ to 10⁴ Sm⁻¹.

6. The PDMS-based composite of claim 3, wherein the Young's modulus of said PDMS-based composite is in the range of 0.9 MPa to 2.1 MPa.

7. The PDMS-based composite of claim 4, wherein the resistivity of said PDMS-based composite is less than 10⁻³ Ωm when a compressive stress is applied on said PDMS-based composite.

8. The PDMS-based composite of claim 4, wherein the resistivity of said PDMS-based composite drops in more than 7 orders of magnitude when a compressive stress applied on said PDMS-based composite is increased from 0 kPa to 250 kPa.

9. The PDMS-based composite of claim 1, wherein said conducting particles are micro-sized metal particles with an average size ranging from 1.2 μm to 5 μm.

10. The PDMS-based composite of claim 1, wherein said PDMS gel further comprises PDMS elastomers and PDMS hardener, wherein the weight ratio of said PDMS elastomers and said PDMS hardener is 10:1 in said PDMS gel.

11. A method of synthesizing PDMS-based composite comprising the steps of:
a) wetting a plurality of conducting particles using a low flash point solvent;
b) mixing said plurality of conducting particles with a PDMS gel;
c) evaporating said low flash point solvent to form a mixture; and
d) curing said mixture to form said PDMS-based composite.

12. The method of claim 11, wherein said conducting particles are selected from a group consisting of silver, nickel, iron and gold.

13. The method of claim 11, wherein said plurality of conducting particles are micro-sized metal particles with an average size ranging from 1.2 μm to 5 μm.

14. The method of claim 11, wherein said low flash point solvent is selected from a group consisting of acetone, hexane and heptane.

15. The method of claim 11, wherein said PDMS gel further comprises PDMS elastomers and PDMS hardener; wherein the weight ratio of said PDMS elastomers and said PDMS hardener is 10:1 in said PDMS gel.

16. The method of claim 11, wherein said evaporating step is conducted under room temperature for 24 hours.

17. The method of claim 11, wherein said curing step further comprises a step of heating said mixture at 60° C. for 48 hours.

18. The method of claim 11 further comprising a step of sonicating said plurality of conducting particles; wherein the duration of said sonicating step is 15 minutes.

19. The method of claim 11, wherein the conductivity of said PDMS-based composite is in the range of 10⁻² Sm⁻¹ to 10⁴ Sm⁻¹.

20. The method of claim 11; wherein the weight percentage of said conducting particles in said PDMS-based composite is in the range of 86% to 91%.
